(19) United States
(12) Patent Application Publication
(10) Pub. No.: US 2003/0083955 A1
(43) Pub. Date: May 1, 2003

(54) Advertisement publishing management method and system

(75) Inventor: Toshio Ookura, Kawasaki (JP)

Correspondence Address: SUGHRUE MION, PLLC, 2100 PENNSYLVANIA AVENUE, N.W., WASHINGTON, DC, 20037, US

(73) Assignee: NEC INFRONTIA CORPORATION

(21) Appl. No.: 10/283,057

(22) Filed: Oct. 30, 2002

(30) Foreign Application Priority Data
Oct. 31, 2001 (JP) 334153/2001

(51) Int. Cl. G06F 17/60

(52) U.S. Cl. 705/26

(57) ABSTRACT

A POS user terminal 2, a mediator terminal 3, a settlement terminal 4 and a 1-st to an n-th advertisement agent shop terminal 5-1 to 5-n are interconnected via an Internet 1 for bi-directional data transmission and reception. The POS user terminal 2 includes a control unit 21, an I/F unit 22, a display unit 23, an input unit 4 and a memory unit 25, and the mediator terminal 3 includes a control unit 31, an I/F unit 32, a display unit 33, an input unit 34, a member database 35, these units having the same functions as those in the POS user terminal 2, a case database 3 and a charging database 37. The 1-st to n-th advertisement agent shop terminals 5-1 to 5-n each includes a control unit 51, an I/F unit 52, a display unit 53, an input unit 54 and a memory unit 55, these units having the same functions as those in the POS user terminal 2. The settlement terminal has a function of executing transfer among the POS user terminal 41, the advertisement shop account 42 and the mediator account 43.

### BACKGROUND OF THE INVENTION

This application claims benefit of Japanese Patent Application No. 2001-334153 filed on Oct. 31, 2001, the contents of which are incorporated by the reference.

The present invention relates to advertisement publishing management method and advertisement publishing management system capable of effective advertisement publishing on POS receipt sheets that is used in POS systems popularly employed article sales shop, service shops, etc.

Usually, receipt sheets used in the POS system are issued from a POS user terminal. Such items as sales time, product name, quantity, price, etc. are printed on a white paper sheet by a printer, thus issuing a receipt of sales amount reception delivered to the customer. However, the customer brings back and stores the delivered receipt in home only in such case as when he or she buys a high price product, and in most low price product buying cases discards the receipt at the register counter. At present, the receipt sheet is hardly made effective use of.

If an advertisement is published on the own product or own project group on the receipt sheet which is heretofore merely discarded, an additional value will be provided on the receipt sheet, and by printing an appropriate advertisement content, it is possible to obtain a profit of the receipt issuer as well as obtaining advertisement of the own company.

Furthermore, by permitting advertisement publishing of other projects on the receipt sheet an additional value may be provided to the receipt sheet, and by printing an appropriate advertisement content, advertisement fees, i.e., advertisement publishing fees can be obtained from the other projects, so that it is possible to reduce the POS management expenditures.

Such advertisement system permits the advertisement publishing project to obtain useful advertisement effect with respect to target customers by making own company advertisement publishing on receipts issued by a well-known retail sales dealer. However, limitations have heretofore been imposed on the business activity of advertisement agent shops in broad ranges by such affairs as the presence of retail sales dealers and advertisement publishing desires. A problem is thus posed that broad range business activities are difficult.

Techniques disclosed in Japanese Patent Laid-Open No. 10-162056 entitled “Method of and System for Executing On-Line Business Transactions Using Intelligent Agent and with Personal Computer as Base”, concerns method of and system for extracting and determining providable data among various data stored in a plurality of servers with respect to contents of a request from a client computer. In other words, a kind of basic status of so-called on-line transactions is disclosed. However, no specific means for managing the advertisement publishing on POS receipt sheets is taught.

Although the advertisement publishing on the POS receipt sheets provides useful advertisement effect to the advertisement publishing project with respect to target customers, limitations have heretofore been imposed on the business activity of advertisement agent shops in broad ranges by such affairs as the presence of retail sales dealers and advertisement publishing desires. The appearance of a system capable of efficient advertisement publishing management by using a communication network such as an Internet, thus has been vehemently demanded.

### SUMMARY OF THE INVENTION

An object of the present invention, therefore, is to provide an advertisement publishing management method and an advertisement publishing management system for POS receipt sheets, in which among the three parties, i.e., the POS user terminal, the advertisement mediator and the advertisement agent shop, it is made possible to carry out a series of operations that the mediator terminal accepts a request of advertisement publishing on receipt sheets from the POS user terminal connected to an Internet or like communication network and transmits the advertisement publishing summary data to the advertisement agent shop terminal for study of the contents and determination of the best content to settle buying and selling concerning the advertisement. Besides, the POS user can reduce the receipt sheet running cost in POS management and obtain advertisement of the own company by delivering advertisement published receipts to customers.

According to an aspect of the present invention, there is provided an advertisement publishing management method comprising: a first step executed in a POS user terminal for transmitting advertisement desire data for publishing an advertisement on POS receipt sheets via a communication network to a mediator terminal; a second step executed in the mediator terminal having received the advertisement desire data for distributing the received advertisement desire data to a plurality of advertisement shop terminals; a third step executed in each of the plurality of advertisement agent shop terminals for judging an advertisement publishing requirement fitting the advertisement desire data received from the mediator terminal and transmitting the judgment result data to the mediator terminal; a fourth step executed in the mediator terminal for selecting and determining an advertisement agent shop terminal pertinent to a case content fitting the desire requirement of the POS user terminal among the plurality of agent shop terminals based on the judgment result data received from the advertisement agent shop terminal; and a fifth step executed in the mediator terminal for transmitting advertisement publishing determination data determined therein to the POS user terminal.

The advertisement publishing management method further comprises a step executed in the advertisement agent shop terminal for paying a price to the POS user; and a step executed in the mediator terminal for receiving a sales service fee corresponding to the price from the POS user terminal. The fifth step includes a step executed in the POS user terminal for transmitting, after reception of the advertisement publishing determination data, negotiation window data with respect to the POS user terminal to the mediator terminal and the advertisement agent shop terminal. The communication network is formed by an Internet. The first step includes a step of inputting data to a plurality of items provided in an input frame in correspondence to pluralities of selection branches. The fourth step includes a step executed by a subordinate terminal unit controlled by the mediator terminal for selecting and determining the advertisement agent shop terminal pertinent to a case content fitting the desire requirement.

According to another aspect of the present invention, there is provided an advertisement publishing management system for POS receipt sheets constituted by inter-connection of a POS user terminal, a mediator terminal and a plurality of advertisement agent shop terminals via a communication network and comprising: a first communication means in a POS user terminal for transmitting advertisement desire data for publishing an advertisement on POS receipt sheets via a communication network to a mediator terminal; a second communication means in the mediator terminal having received the advertisement desire data for distributing the received advertisement desire data to a plurality of advertisement shop terminals; a third communication means in each of the plurality of advertisement agent shop terminals for judging an advertisement publishing requirement fitting the advertisement desire data received from the mediator terminal and transmitting the judgment result data to the mediator terminal; a fourth communication means in the mediator terminal for selecting and determining an advertisement agent shop terminal pertinent to a case content fitting the desire requirement of the POS user terminal among the plurality of agent shop terminals based on the judgment result data received from the advertisement agent shop terminal; and a fifth communication means in the mediator terminal for transmitting advertisement publishing determination data determined therein to the POS user terminal.

The advertisement publishing management system further comprises a means in the advertisement agent shop terminal for paying a price to the POS user; and a means in the mediator terminal for receiving a sales service fee corresponding to the price from the POS user terminal. The fifth communication means includes a means in the POS user terminal for transmitting, after reception of the advertisement publishing determination data, negotiation window data with respect to the POS user terminal to the mediator terminal and the advertisement agent shop terminal. The communication network is formed by an Internet. The first communication means includes a step of inputting data to a plurality of items provided in an input frame in correspondence to pluralities of selection branches. The fourth communication means includes a step executed by a subordinate terminal unit controlled by the mediator terminal for selecting and determining the advertisement agent shop terminal pertinent to a case content fitting the desire requirement.

According to other aspect of the present invention, there is provided an advertisement publishing management method comprising: a step executed in a POS user terminal for accessing mediator terminal via Internet; a step executed in the mediator terminal for transmitting advertisement desire data to the POS user terminal; a step executed in the POS user terminal for showing the contents of the advertisement desire data on a display unit, and after inputting desire data, transmitting as advertisement desire data to the mediator terminal; a step executed in the mediator terminal, in response to receipt of the advertisement desire data and after confirmation with reference to member database that the POS user is a member, for extracting a case number from case database, inputting the case number data, and transmitting the advertisement publishing desire data via Internet to a plurality of advertisement agent shop terminals as members; a step executed in the advertisement agent shop terminals, is response to receipt of the advertisement desire data, transmitting publishing request data including desired publishing price and desired publishing price of the advertisement publishing to the mediator terminal; a step executed in the mediator terminal, after receiving the publishing desire data, for determining a publishing desirer with the highest publishing price among the advertisement publishing request data as advertisement agent shop, and transmitting the advertisement agent shop determination notice data to the POS user terminal and the pertinent advertisement shop terminal; a step executed in the POS user terminal, in response to receipt of the advertisement agent shop determination notice, for transmitting advertisement publishing negotiation window data to the mediator terminal and the pertinent advertisement agent shop terminal; a step executed in the mediator terminal having received the negotiation window data, for judging that buying and selling have been settled, extracting the publishing price of the advertisement publishing from the charge database, and transmitting the settlement data including the publishing price and the payment term via Internet to a settlement terminal; a step executed in the settlement terminal, in response to receipt of the settlement data, for making first transfer of the publishing price amount of the advertisement publishing from an advertisement agent shop account to the POS user account in a payment terminal based on the first settlement data; a step executed in the mediator terminal, for extracting a sales service fee of the advertisement publishing from the charge database, and transmitting the settlement data including the sales service fee and the payment data as second settlement data to the settlement terminal; and a step executed in the settlement terminal, in response to receipt of the second settlement data, for making second transfer of the sales service fee amount of the advertisement publishing from the POS user account to the mediator account based on the second settlement data.

The transmission from the mediator terminal to the advertisement agent shop terminal is executed for limited members having bearing on the advertisement desire. The advertisement publishing management method further comprises a step executed in the pertinent advertisement agent shop terminal for receiving the advertisement agent shop determination notice data from the mediator terminal and receives the advertisement publishing negotiation window data from the POS user terminal. The payment of the publishing price amount and the sales service fee amount is made after the advertisement publishing has been made by the business right advertisement agent shop. The payment of the publishing price amount and the sales service fee amount is made every time between the relevant parties. The payment is substituted for by the entrance fee and membership fees of a member system.

Other objects and features will be clarified from the following description with reference to attached drawings.

### BRIEF DESCRIPTION OF THE DRAWINGS

FIG. 1 shows an overall constitution of an embodiment of an advertisement publishing management system according to the present invention;

FIGS. 2 and 3 are flowcharts showing operation of the embodiment shown in FIG. 1;

FIG. 4 is a frame showing the contents of the advertisement desire data on the POS receipt sheet shown in FIG. 1; and

FIG. 5 is a frame showing the contents of the case summary data on the POS receipt sheet shown in FIG. 1.

### PREFERRED EMBODIMENTS OF THE INVENTION

Preferred embodiments of the present invention will now be described with reference to the drawings.

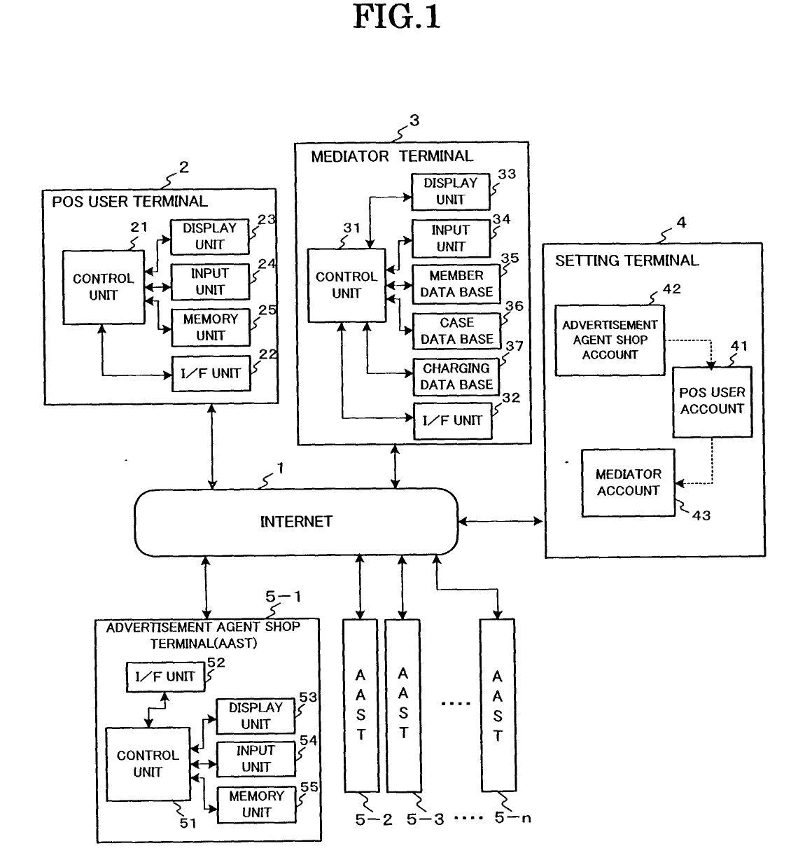

This embodiment is an application of the present invention to a POS system provided in an article sales shop. FIG. 1 shows an overall constitution of an advertisement publishing management system for managing the publishing of advertisements on POS sheets. In the system, a POS user terminal 2, a mediator terminal 3, a settling terminal 4 and advertisement mediator terminals (i.e., 1-st to n-th advertisement mediator terminals 5-1 to 5-n) are interconnected via an Internet 1 as one form of communication network for bi-directional data transmission and reception.

The POS user terminal 2 is installed in an article sales shop or the like. The advertisement publishing printed on receipt sheets includes general advertisement, such as brand names, project names, product images, campaign notices, new product notice and coupon displays.

The POS user terminal 2 is constituted by a data processor such as personal computer, and includes an I/F (interface) part 22 for connection to the Internet 1, a display unit 23 for displaying various guide frames, an input unit 24 for inputting data, a memory unit 25 for storing various data and a control unit 21 for compositely controlling these units.

The POS user terminal 2 has a function of accessing the mediator terminal 3 connected to the Internet 1 for displaying advertisement desire summary input frame data on the display unit 23, a function of inputting the advertisement desire summary data from the input unit 24 and a function of transmitting the advertisement desire summary data via the Internet 1 to the mediator terminal 3.

The advertisement desire summary data includes desired price for publishing, member number and so forth as well as the summary of the advertisement publishing content. The POS user terminal 3 further has a function of receiving advertisement agent shop determination notice data from the mediator terminal 2 and transmitting advertisement publishing negotiation window negotiation data via the Internet 1 to the mediator terminal 3 and the advertisement agent shop terminals (i.e., 1-st to n-th advertisement agent shop terminals 5-1 to 5-n).

The mediator terminal 3 is used by a mediator mediating for advertisement publishing, and is constituted by such a data processor as a work station server. The mediator terminal 3 includes a control unit 31, an I/F unit 32, a display unit 33, an input unit 34, a member data base 35 for storing member data such as the name and address of members, business summary and member numbers, these units having the same functions as those in the POS user terminal 2, a case data base 36 for storing the contents and case numbers sales advertisement desires, and charging data bases 37 for storing sales prices of advertisement publishing and data of sales service fees predetermined between agent and member.

The mediator terminal 3 has a function of transmitting advertisement desire summary input frame data via the Internet 1 to the POS user terminal 2 in response to a request from the POS user terminal 2, a function of adding case number data to advertisement desire summary data received from the POS user terminal 2, a function of transmitting the advertisement desire summary data to a plurality of advertisement agent shop terminals (i.e., 1-st to n-th advertisement agent shop terminals 5-1 to 5-n, a function of receiving advertisement publishing data from advertisement agent shop terminals (i.e., 1-st to n-th advertisement agent shop terminals 5-1 to 5-n and selecting and determining an advertisement agent shop, a function of transmitting advertisement agent shop determination notice data of the fact that an advertisement agent shop has been determined to the POS user terminal 2 and the advertisement agent shop terminal, and a function of transmitting, after reception of advertisement publishing negotiation window data from the POS user terminal 2, settlement data via the Internet 1 to the settling terminal 4. The settlement data includes at least the sales price and sales service fee of advertisement publishing and the payment term.

The advertisement agent shop terminals (i.e., 1-st to n-th advertisement agent shop terminals 5-1 to 5-n) are data processors such as personal computers. In this embodiment, n advertisement agent shop terminals having the same construction are connected. Each of these advertisement agent shop terminals includes a control unit 51, an I/F unit 52, a display unit 53, an input unit 54 and a memory unit 55, these units having the same functions as those in the POS user terminal 2.

The 1-st advertisement agent shop terminal 5-1 has a function of receiving advertisement desire summary data from the POS user terminal 2 connected to the Internet 1, a function of inputting of publishing request data as requirements for publishing the advertisement data, a function of transmitting the publishing request data to the mediator terminal 3, and a function of receiving advertisement publishing negotiation window detail data from the POS user terminal 2 from the Internet 1.

The settlement terminal 4 is provided in a bank or the like. The settlement terminal 4 receives settlement data from the mediator terminal 2, and transfers the sales price amount of the advertisement publishing from the advertisement agent shop account 42 to the POS user account 41 at the transfer date based on the settlement data. Likewise, the settlement terminal 4 has a function of transferring the sales service fee amount of the advertisement publishing from the POS user account 41 to the mediator account 43 at the transfer date based on the settlement data from the mediator terminal 3.

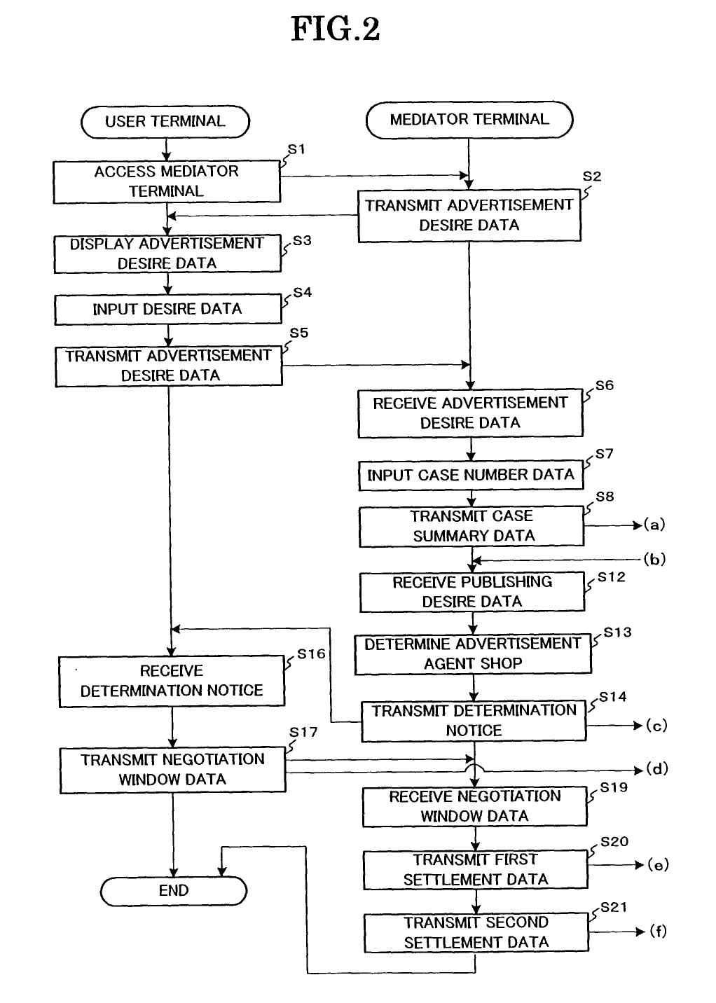

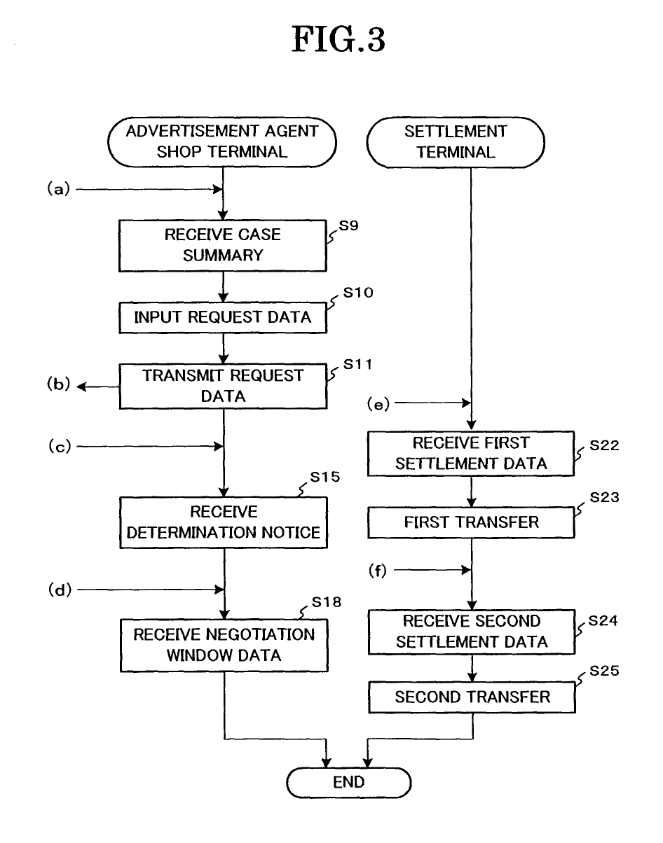

Now, the operation of the advertisement publishing management system for POS receipt sheets having the above construction will now be described with reference to the flow charts shown in FIGS. 2 and 3. In FIG. 2, labeled (a) to (f) are relay points, which are produced for the sake of drawing preparation and correspond to those of like reference symbols in FIG. 3.

The POS user accesses the mediator terminal 3 from the own POS user terminal 2 via the Internet 1 (step S1), and in response to this access the mediator terminal 3 transmits the advertisement desire data to the POS user terminal 2 (step S2).

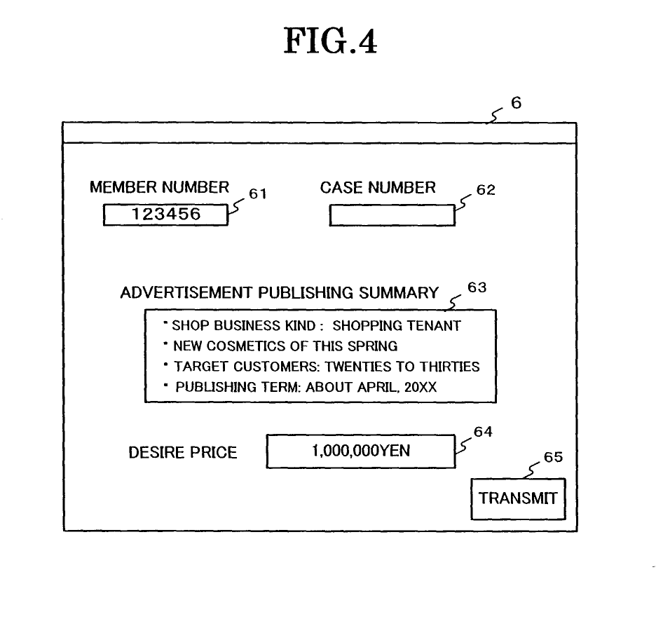

The frame showing the contents of the advertisement desire data is displayed as input frame 6 as shown in FIG. 4 on the display unit 23 in the POS user terminal 2 (step S3), and after desire data has been inputted, it is transmitted as advertisement desire data to the mediator terminal 3 (steps S4 and S5).

In the input frame 6, a number preliminarily allotted to the POS user, for instance “123456”, is inputted in the item of a member number 61 from the input unit 24. No case number 62 is inputted in the case number item 62 this time because it is determined later. Desired matter is inputted in the column of the advertisement publishing summary 63. For example, “shopping tenant” is inputted as shop business kind, “new cosmetics of this spring” as subject product, “twenties to thirties” as the age range of target customers, and “about April, 20xx” as the publishing term.

In a publishing desire price 64, 1,000,000 yen, for instance, is inputted. When the inputting in all the items has been completed, the contents in the input frame 6 are transmitted to the mediator terminal 3 by clicking a transmit push-button 65. While the desire price of the POS user is inputted in the “publishing desire price” 64, it may not be inputted.

When the mediator terminal 3 receives the advertisement desire data summary (step S6), it confirms with reference to the member database 35 that the POS user is a member, and then extracts the case number from the case database 36 and inputs the case number data (step S7). The mediator terminal 3 then transmits the advertisement publishing desire summary data via the Internet 1 to the 1-st to n-th advertisement agent shop terminals 5-1 to 5-n as members (step S8). The transmission from the mediator terminal 3 to the advertisement agent shop terminal may be executed for all members or for limited members having bearing on the advertisement desire.

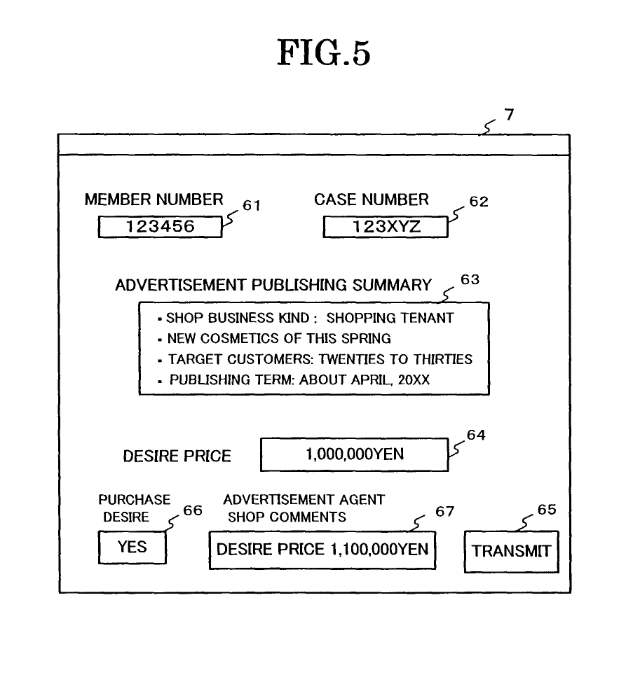

When each of the 1-st to n-th advertisement agent shop terminals 5-1 to 5-n receives the advertisement desire data (step S9), an input frame 7 as shown in FIG. 5 is displayed on the display unit 53. Thus, publishing request data such as the “desired publishing price: 1,100,000 yen” and desired publishing price of the advertisement publishing are inputted to an advertisement agent shop comment column 67 by using the input unit 54 (step S10), then “Yes” is inputted to a purchase desire item 66, and then the data are transmitted to the mediator terminal 3 by clicking the transmit push-button 65 on the input frame 7 (step S11).

The mediator terminal 3, after receiving the publishing desire data (step S12), determines a publishing desirer with the highest publishing price among the advertisement publishing request data having received up to a certain predetermined date (step S13) as advertisement agent shop (step S13). The determined price data stored to in the charge database 37 of the mediator terminal 3. Subsequently, the mediator terminal 3 transmits advertisement agent shop determination notice data to the POS user terminal 2 and also to the pertinent advertisement shop terminal among the 1-st to n-th advertisement agent shop terminals 5-1 to 5-n (step S14).

When the POS user terminal 2 receives the advertisement agent shop determination notice (step S16), it transmits advertisement publishing negotiation window data to the mediator terminal 3 and the pertinent advertisement agent shop terminal among the 1-st to n-th advertisement agent shop terminals 5-1 to 5-n (step S17).

When the mediator terminal 3 having received the negotiation window data (step 19) receives the advertisement publishing negotiation window data, it judges that buying and selling have been settled, then extracts the publishing price of the advertisement publishing from the charge database 37, and transmits the settlement data such as the publishing price and the payment term via the Internet 1 to the settlement terminal 4 (step S20).

When the settlement terminal 2 receive the settlement data (i.e., first settlement data) (step S22), it makes first transfer of the publishing price amount of the advertisement publishing from the advertisement agent shop account 42 to the POS user account 41 in the payment terminal based on the first settlement data (step S23).

As for the sales service fee, the mediator terminal 3 likewise extracts the sales service fee of the advertisement publishing from the charge database 37, and transmits the settlement data such as the sales service fee and the payment data as second settlement data to the settlement terminal 4 (step S21).

When the settlement terminal 4 receives the second settlement data (step S24), it makes second transfer of the sales service fee amount of the advertisement publishing from the POS user account 41 to the mediator account 43 based on the second settlement data (step S25).

During this time, the pertinent advertisement agent shop terminal among the 1-st to n-th advertisement agent shop terminals 5-1 to 5-n receives the advertisement agent shop determination notice data from the mediator terminal 3 (step S15), and receives the advertisement publishing negotiation window data from the POS user terminal 2 (step S18).

The payment of the publishing price amount and the sales service fee amount may be made after the advertisement publishing has been made by the business right advertisement agent shop. Also, the payment of the publishing price amount and the sales service fee amount may be made every time between the relevant parties as described before, or it may be made in the form of buying by the mediator. Furthermore, the payment may be substituted for by the entrance fee and membership fees of a member system.

In this embodiment, the entirety of the “advertisement publishing management method for POS receipt sheets” is operated by adding a step of paying the price from the pertinent agent shop terminal among the 1-st to n-th advertisement agent shop terminals 5-1 to 5-n to the user of the POS user terminal 2 and a step, in which the mediator terminal 3 receives the sales service fee corresponding to the price from the POS user terminal 2. These steps, however, may of course be executed in a separate system.

Also, in the embodiment, the Internet 1 is used as communication network. It is of course possible to use as the communication network an LAN for composite connection of the entirety of the POS user terminal 2, the mediator terminal 3, the settlement terminal 4 and the 1-st to n-th advertisement agent shop terminals 5-1 to 5-n.

Furthermore, in this embodiment the input frames 6 and 7 with pluralities of items provided therein are used for transmitting advertisement desire data, and inputting data in these pluralities of items in correspondence to pluralities of selection branches. The frames may be of any layouts. Alternatively, it is of course possible to input data in any other form than the use of these frames.

As has been made apparent from the foregoing, the advertisement publishing management method and advertisement publishing management system for POS receipt sheets according to the present invention, permit extremely enlarging the scope of advertisement publishing media in the business activities of advertisement agent shops, increasing the advertisement publishing desire project selection range and efficient business activities. Besides, since the POS user can obtain income of advertisement in POS management, it can reduce the receipt sheet running cost. This means that advertisement publishing sheets can be delivered to more customers for broader advertisement of the own company.

Thus, among the three parties, i.e., the POS user terminal, the advertisement mediator and the advertisement agent shop, it is possible to carry out a series of operations that the mediator terminal accepts a request of advertisement publishing on receipt sheets from the POS user terminal connected to an Internet or like communication network and transmits the advertisement publishing summary data to the advertisement agent shop terminal for study of the contents and determination of the best content to settle buying and selling concerning the advertisement. Besides, the POS user can reduce the receipt sheet running cost in POS management and obtain advertisement of the own company by delivering advertisement published receipts to customers.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An advertisement publishing management method comprising:
a first step executed in a POS user terminal for transmitting advertisement desire data for publishing an advertisement on POS receipt sheets via a communication network to a mediator terminal;
a second step executed in the mediator terminal having received the advertisement desire data for distributing the received advertisement desire data to a plurality of advertisement shop terminals;
a third step executed in each of the plurality of advertisement agent shop terminals for judging an advertisement publishing requirement fitting the advertisement desire data received from the mediator terminal and transmitting the judgment result data to the mediator terminal;
a fourth step executed in the mediator terminal for selecting and determining an advertisement agent shop terminal pertinent to a case content fitting the desire requirement of the POS user terminal among the plurality of agent shop terminals based on the judgment result data received from the advertisement agent shop terminal; and
a fifth step executed in the mediator terminal for transmitting advertisement publishing determination data determined therein to the POS user terminal.

2. The advertisement publishing management method for POS receipt sheets according to claim 1, further comprising:
a step executed in the advertisement agent shop terminal for paying a price to the POS user; and
a step executed in the mediator terminal for receiving a sales service fee corresponding to the price from the POS user terminal.

3. The advertisement publishing management method for POS sheets according to claim 1, wherein the fifth step includes a step executed in the POS user terminal for transmitting, after reception of the advertisement publishing determination data, negotiation window data with respect to the POS user terminal to the mediator terminal and the advertisement agent shop terminal.

4. The advertisement publishing management method for POS receipt sheets according to claim 1, wherein the communication network is formed by an Internet.

5. The advertisement publishing management method for POS receipt sheets according to claim 1, wherein the first step includes a step of inputting data to a plurality of items provided in an input frame in correspondence to pluralities of selection branches.

6. The advertisement publishing management method for POS receipt sheets according to claim 1, wherein the fourth step includes a step executed by a subordinate terminal unit controlled by the mediator terminal for selecting and determining the advertisement agent shop terminal pertinent to a case content fitting the desire requirement.

7. An advertisement publishing management system for POS receipt sheets constituted by inter-connection of a POS user terminal, a mediator terminal and a plurality of advertisement agent shop terminals via a communication network and comprising:
a first communication means in a POS user terminal for transmitting advertisement desire data for publishing an advertisement on POS receipt sheets via a communication network to a mediator terminal;
a second communication means in the mediator terminal having received the advertisement desire data for distributing the received advertisement desire data to a plurality of advertisement shop terminals;
a third communication means in each of the plurality of advertisement agent shop terminals for judging an advertisement publishing requirement fitting the advertisement desire data received from the mediator terminal and transmitting the judgment result data to the mediator terminal;
a fourth communication means in the mediator terminal for selecting and determining an advertisement agent shop terminal pertinent to a case content fitting the desire requirement of the POS user terminal among the plurality of agent shop terminals based on the judgment result data received from the advertisement agent shop terminal; and
a fifth communication means in the mediator terminal for transmitting advertisement publishing determination data determined therein to the POS user terminal.

8. The advertisement publishing management system for POS receipt sheets according to claim 7, further comprising:
a means in the advertisement agent shop terminal for paying a price to the POS user; and
a means in the mediator terminal for receiving a sales service fee corresponding to the price from the POS user terminal.

9. The advertisement publishing management system for POS sheets according to claim 7, wherein the fifth communication means includes a means in the POS user terminal for transmitting, after reception of the advertisement publishing determination data, negotiation window data with respect to the POS user terminal to the mediator terminal and the advertisement agent shop terminal.

10. The advertisement publishing management system for POS receipt sheets according to claim 7, wherein the communication network is formed by an Internet.

11. The advertisement publishing management system for POS receipt sheets according to claim 7, wherein the first communication means includes a step of inputting data to a plurality of items provided in an input frame in correspondence to pluralities of selection branches.

12. The advertisement publishing management system for POS receipt sheets according to claim 7, wherein the fourth communication means includes a step executed by a subordinate terminal unit controlled by the mediator terminal for selecting and determining the advertisement agent shop terminal pertinent to a case content fitting the desire requirement.

13. An advertisement publishing management method comprising:
a step executed in a POS user terminal for accessing mediator terminal via Internet;
a step executed in the mediator terminal for transmitting advertisement desire data to the POS user terminal;
a step executed in the POS user terminal for showing the contents of the advertisement desire data on a display unit, and after inputting desire data, transmitting as advertisement desire data to the mediator terminal;
a step executed in the mediator terminal, in response to receipt of the advertisement desire data and after confirmation with reference to member database that the POS user is a member, for extracting a case number from case database, inputting the case number data, and transmitting the advertisement publishing desire data via Internet to a plurality of advertisement agent shop terminals as members;
a step executed in the advertisement agent shop terminals, is response to receipt of the advertisement desire data, transmitting publishing request data including desired publishing price and desired publishing price of the advertisement publishing to the mediator terminal;
a step executed in the mediator terminal, after receiving the publishing desire data, for determining a publishing desirer with the highest publishing price among the advertisement publishing request data as advertisement agent shop, and transmitting the advertisement agent shop determination notice data to the POS user terminal and the pertinent advertisement shop terminal;
a step executed in the POS user terminal, in response to receipt of the advertisement agent shop determination notice, for transmitting advertisement publishing negotiation window data to the mediator terminal and the pertinent advertisement agent shop terminal;
a step executed in the mediator terminal having received the negotiation window data, for judging that buying and selling have been settled, extracting the publishing price of the advertisement publishing from the charge database, and transmitting the settlement data including the publishing price and the payment term via Internet to a settlement terminal;
a step executed in the settlement terminal, in response to receipt of the settlement data, for making first transfer of the publishing price amount of the advertisement publishing from an advertisement agent shop account to the POS user account in a payment terminal based on the first settlement data;
a step executed in the mediator terminal, for extracting a sales service fee of the advertisement publishing from the charge database, and transmitting the settlement data including the sales service fee and the payment data as second settlement data to the settlement terminal; and
a step executed in the settlement terminal, in response to receipt of the second settlement data, for making second transfer of the sales service fee amount of the advertisement publishing from the POS user account to the mediator account based on the second settlement data.

14. The advertisement publishing management method according to claim 13, wherein the transmission from the mediator terminal to the advertisement agent shop terminal is executed for limited members having bearing on the advertisement desire.

15. The advertisement publishing management method according to claim 13, further comprising a step executed in the pertinent advertisement agent shop terminal for receiving the advertisement agent shop determination notice data from the mediator terminal and receives the advertisement publishing negotiation window data from the POS user terminal.

16. The advertisement publishing management method according to claim 13, wherein the payment of the publishing price amount and the sales service fee amount is made after the advertisement publishing has been made by the business right advertisement agent shop.

17. The advertisement publishing management method according to claim 13, wherein the payment of the publishing price amount and the sales service fee amount is made every time between the relevant parties.

18. The advertisement publishing management method according to claim 13, wherein the payment is substituted for by the entrance fee and membership fees of a member system.
